(19) United States
(12) Patent Application Publication
(10) Pub. No.: US 2006/0271726 A1
(43) Pub. Date: Nov. 30, 2006

(54) [FLASH MEMORY STORAGE DEVICE WITH DATA DISPLAY]

(75) Inventor: Wee-Kuan Gan, TAIPEI (TW)

Correspondence Address: PHISON ELECTRONICS CORPORATION, 2F-4. NO. 148, SEC. 4, CHUNG HSIAO EAST ROAD, TAIPEI, TW

(73) Assignee: PHISON ELECTRONICS CORP., Chutung Town, Hsinchu Hsien (TW)

(21) Appl. No.: 11/163,518

(22) Filed: Oct. 21, 2005

(30) Foreign Application Priority Data
May 27, 2005 (TW) 094117580

(51) Int. Cl. G06F 12/00

(52) U.S. Cl. 711/103

(57) ABSTRACT

A flash memory storage device with data display is disclosed. The flash memory storage device comprises a flash memory, a controller and a cholesteric liquid crystal. The flash memory comprises an execution program for reading data from the flash memory. The controller is connected to the flash memory and comprises at least one flash memory interface for communicating and transmitting information to the flash memory. The cholesteric liquid crystal is connected to the controller and is capable of displaying information transmitted by the controller.

This application claims the priority benefit of Taiwan patent application number 094117580 filed on May 27, 2005.

### BACKGROUND OF THE INVENTION

1. Field of the invention

The present invention relates to a flash memory storage device with data display, and more particularly to a storage device to display flash memory data via the cholesteric liquid crystal.

2. Description of related art

With the progressive improvement in electronic technology, the electronic products such as computer, cellular phone, memory stick and digital camera are widely used in our daily life. And, increased functions of the electronic products have changed our life styles accordingly. These electronic products all need storage devices for saving data. Besides, the flash memory has become widely popular for its advantageous characteristics, such as non-volatile, shock proof, high density and the like. Among many portable electronic devices, the flash memory has taken the place of EEPROM or memory requiring battery. Because the semiconductor technology is mature, it is possible to increase both the storage density and transmission speed of the flash memory, and therefore of flash memory has gradually replaced the conventional storage media, such as the hard disk driver.

Nowadays, almost every user possesses electronic products with flash memory storage device, and almost every electronic product contains data storage function. When using the electronic products to save data, first, the electronic products must be turned on to find out the storage capacity or the remaining storage space available via display to give the user some idea about the storage space available and then decide which of the electronic products should be used to save the data of interest. The above-mentioned inconvenience may cause substantial amount of energy wastage and also adversely affect the service life span of the electronic products due repeated turning on and off of the electronic products. Furthermore, the consumers usually purchase popular products on the market; therefore several users may often possess same kind of electronic products that could easily cause misunderstandings as to the ownership.

Furthermore, the memory stick with the flash memory has become a mainstream multi-media electronic product. Besides saving and portability, the memory stick can also play the MP3 music, and depending on the storage capacity, the memory stick can storage at least one hundred songs, thus user can listen to the music anytime and anywhere. The conventional memory stick with the music player function is similar to the CD ROM. After the memory stick is turned on, the memory stick is ready to play the first music. If the user wants to list any particular music of interest, he must search the music by memory or recording the track position.

The technology is being developed to satisfy the great need of the liquid crystal display, and a cholesteric liquid crystal is developed to provide the advantageous features such as memory, Multi-Domain Vertical Alignment and non-twinkle. The power consumption of the cholesteric liquid crystal is 1/50 or less than the conventional LCD. Such cholesteric liquid crystal only consumes power when the crystal orientation changes while displaying. In other words, when the display is still, no power will be consumed. Therefore, the cholesteric liquid crystal is capable of continuously displaying the last picture without consuming any power, and even when the power supply to the cholesteric display is cut off.

With the above advantages of the cholesteric liquid crystal, it is highly desirable to apply the cholesteric liquid crystal into the electronic products with flash memory.

### SUMMARY OF THE INVENTION

Accordingly, in the view of the foregoing, the present inventor makes a detailed study of related art to evaluate and consider, and uses years of accumulated experience in this field, and through several experiments, to create a new a flash memory storage device with data display.

According to an aspect of the present invention, the execution program to retrieve data from the storage device is executed and the retrieved data is transmitted to the cholesteric liquid crystal of the storage device for displaying. The last information of the storage device can be displayed in the cholesteric liquid crystal before using it, so that the user can visually learn and use it.

According to another aspect of the present invention, the execution program is continuously renewing the data displayed in the cholesteric liquid crystal of the storage device to display the memory storage status so that the user may easily become aware about the last memory status of the storage device.

To achieve these and other objects of the present invention, the storage device of the present invention comprises a controller connected to a cholesteric liquid crystal and a flash memory respectively. The controller comprises at least a flash memory interface for communicating with and transmitting data to the flash memory. When the storage device connected to a host end via a transmission interface, the execution program of the host end or the storage device gives the data reading command according to the user or the execution program itself to retrieve the data from the flash memory of the storage device and transmit the retrieved data to the cholesteric liquid crystal for displaying the data so that the user may become aware of the last data in the flash memory of the storage device before using it.

### BRIEF DESCRIPTION OF THE DRAWING

For a more complete understanding of the present invention, reference will now be made to the following detailed description of preferred embodiments taken in conjunction with the following accompanying drawings.

FIG. 1 is a block diagram according to a preferred embodiment of the present invention.

FIG. 2 is a block diagram according to another preferred embodiment of the present invention.

### DETAILED DESCRIPTION OF EMBODIMENTS

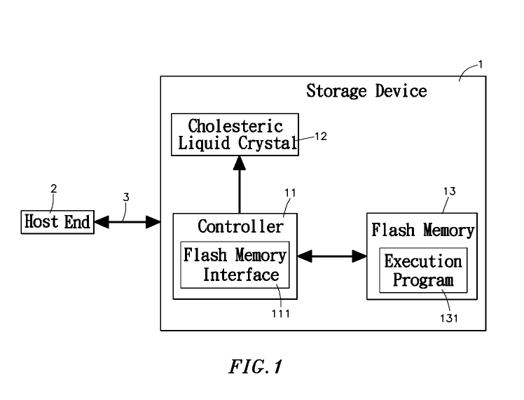

Referring to FIG. 1, a storage device 1 in accordance with the present invention is shown comprised of a controller 11, a cholesteric liquid crystal 12 and a flash memory 13.

The controller 11 comprises at least one flash memory interface 111 for communicating with the flash memory 13 such that when the storage device 1 is connected to a host end 2 via a transmission interface 3, for example USB, PCI and IDE, the host end 2 retrieves stored data from or transmit data to the flash memory 13 via the flash memory interface 111 of the controller 11.

The cholesteric liquid crystal 12 is connected to the controller 11 and is able to display the data of the flash memory 13.

The flash memory 13 is connected to the controller 11 and has an execution program 131 for controlling data display via the cholesteric liquid crystal 12.

When the storage device 1 is connected to the host end 2 via the transmission interface 3, the storage device 1 informs the host end 2 with Auto Run function to automatically execute the execution program 131 stored in the flash memory 13. The execution program 131 commands to read the present status of the storage device 1, for example partition table, thus the execution program 131 can retrieve information including disk label, total storage capacity, used capacity, and last operation time and date of the flash memory 13 and this retrieved information is displayed by the cholesteric liquid crystal 12 so that the user would become aware of the last status of the storage device 1. Besides, the cholesteric liquid crystal 12 has the feature of being able to display the last picture after power supply is terminated. Therefore, even without turning on the storage device 1, the last picture such as disk label, total storage capacity, used capacity, and last operation time and date is also displayed so that the user may visually learn the last status of the storage device 1. When the user plays the MP3 music stored in the flash memory 13, the cholesteric liquid crystal 12 may also displaying the information of the playing song retrieved by the execution program 131 for facilitating the user to search songs of interest. Furthermore, the user may also learn if the storage device 1 was used by others by checking the displayed information.

Furthermore, when the user uses the storage device 1, the capacity of the flash memory 13 of the storage device 1 changes according to its usage and the data displayed in the cholesteric liquid crystal 12 also corresponding changes continuously through the execution program 131. Thus, the user is able to visually learn the capacity status of the flash memory 13 of the storage device 1 on real time basis. As the cholesteric liquid crystal 12 merely consumes 1/50 or less of the power than the conventional LCD, and therefore, application of cholesteric liquid crystal 12 in electronic products would greatly reduce the power consumption and thereby substantially reduce the operating cost.

The execution program 131 can load in the user's information, for example, the user's name, display pictures and words in the cholesteric liquid crystal 12 and render the cholesteric liquid crystal 12 as a built-in label of the storage device 1. The advantage of this feature is that when other users possesses the same kind of the storage device 1, the cholesteric liquid crystal 12 displayed the personal information differentiates from such similar storage device 1. The execution program 131 may be load in pictures or animations by the programmer or user in the cholesteric liquid crystal 12 during the sleep mode of the storage device 1 to notify the user and look attractive to promote sale.

Additionally, the storage device 1 can be a memory stick or a MP3 player.

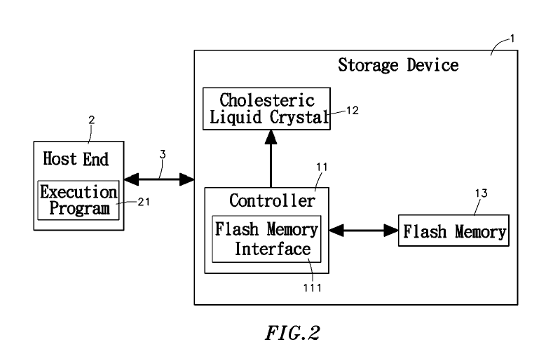

As shown in FIG. 2, the storage device 1 comprises a controller 11 connected to a cholesteric liquid crystal 12 and a flash memory 13 respectively. The controller 11 comprises at least one flash memory interface 111 for communicating with the flash memory and transmitting data to the flash memory 13. The storage device 1 is connected to a host end 2 via a transmission interface 3, and the host end 2 comprises an execution program 21.

When operating the storage device 1, the execution program 21 commands data reading according to the user's command or set-up in the execution program 21 to read the present status of the storage device 1, for example partition table, via the transmission interface 3. Thus, the execution program 21 may retrieve the disk label, total capacity, used capacity, and last operation time and date of the flash memory 13 in the storage 1 and transmits to the storage device 1 through the transmission interface 3 to display by the cholesteric liquid crystal 12 so that the user may become aware of the last status of the storage device 1. Because the cholesteric liquid crystal 12 comprises the feature of displaying the last picture after power supply is terminated, therefore, even before turning on the storage device 1, the user can learn the last status information of the storage device 1 such as the last operation time and date, disk label, total capacity, used capacity. Besides, the user can learn if the storage device 1 was used by others by checking the displayed information.

Furthermore, when the user uses the storage device 1, the capacity of the flash memory 13 of the storage device 1 changes according to its usage and the data displayed in the cholesteric liquid crystal 12 also corresponding changes continuously through the execution program 21 of the host end 2. Thus, the user is able to visually learn the capacity status of the flash memory 13 of the storage device 1 on real time basis. As the cholesteric liquid crystal 12 merely consumes 1/50 or less of the power than the conventional LCD, and therefore, application of cholesteric liquid crystal 12 in electronic products would greatly reduce the power consumption and thereby substantially reduce the operating cost.

The transmission interface 3 may comprise USB, PCI or IDE, and the flash memory 13 may comprise NOR flash memory, NAND flash memory, DINOR flash memory or AND flash memory.

The host end 2 may be a computer or a PDA, and the storage device 1 may be a memory stick or a MP3 player.

Accordingly, the flash memory storage device with data display of the present invention has at least the following advantages.

1. The execution program is adopted for reading the data of the flash memory for the cholesteric liquid crystal of the storage device to display. The cholesteric liquid crystal is capable of displaying the last picture after power supply is terminated; therefore it is possible to learn the last information before turning on the storage device.

2. The execution program is adopted for continuously changing the displayed information for displaying in the cholesteric liquid crystal so that the user may be able to learn the capacity status of the flash memory of the storage device during the usage of the storage device. Besides, the cholesteric liquid crystal merely consumes 1/50 or less of the power than the conventional LCD, therefore the operating cost of the cholesteric liquid crystal can be substantially reduced.

3. The execution program is adopted for loading in user's information for displaying in the cholesteric liquid crystal rendering the cholesteric liquid crystal as a built-in label of the storage device so that confusion with other similar storage devices owned by the others may be effectively avoided. The execution program may also be adopted for playing pictures or animations during the sleep mode of the storage device to notify the user and look attractive to promote sale.

While the invention has been described in conjunction with a specific best mode, it is to be understood that many alternatives, modifications, and variations will be apparent to those skilled in the art in light of the foregoing description. Accordingly, it is intended to embrace all such alternatives, modifications, and variations in which fall within the spirit and scope of the included claims. All matters set forth herein or shown in the accompanying drawings are to be interpreted in an illustrative and non-limiting sense.

What is claimed is:

1. A flash memory storage device with data display, comprising:
a flash memory, comprising an execution program for reading data from said flash memory;
a controller, connected to said flash memory, comprising at least one flash memory interface for communicating and transmitting information to said flash memory; and
a cholesteric liquid crystal, connected to said controller, capable of displaying information transmitted by said controller.

2. The flash memory storage device with data display according to claim 1, wherein said storage device is connected to a host end via a transmission interface.

3. The flash memory storage device with data display according to claim 2, wherein said execution program command by itself or by said host end to read data of said flash memory.

4. The flash memory storage device with data display according to claim 2, wherein said transmission interface comprises an USB.

5. The flash memory storage device with data display according to claim 2, wherein said transmission interface comprises a PCI.

6. The flash memory storage device with data display according to claim 1, wherein said storage device comprises a memory stick.

7. The flash memory storage device with data display according to claim 1, wherein said storage device comprises a MP3 player.

8. A flash memory storage device with data display, comprising:
a flash memory;
a cholesteric liquid crystal; and
a controller, connected to said flash memory and said cholesteric liquid crystal, comprising at least one flash memory interface for communicating and transmitting information to said flash memory, wherein when the storage device is connected to a host end via a transmission interface, an execution program of said host end is executed to read data according to user's or its' own command through said transmission interface to read last information of said storage device and transmit said last information via said transmission interface to said cholesteric liquid crystal of said storage device for displaying.

9. The flash memory storage device with data display according to claim 8, wherein said transmission interface comprises an USB.

10. The flash memory storage device with data display according to claim 8, wherein said transmission interface comprises a PCI.

11. The flash memory storage device with data display according to claim 8, wherein said host end comprises a computer.

12. The flash memory storage device with data display according to claim 8, wherein said host end comprises a PDA.

13. The flash memory storage device with data display according to claim 8, wherein said storage device comprises a memory stick.

14. The flash memory storage device with data display according to claim 8, wherein said storage device comprises a MP3.
